(19) United States
(12) Patent Application Publication
(10) Pub. No.: US 2024/0114208 A1
(43) Pub. Date: Apr. 4, 2024

(54) SYSTEM AND METHOD FOR HEIGHTENED VIDEO REDACTION BASED ON AUDIO DATA

(71) Applicant: MOTOROLA SOLUTIONS, INC., Chicago, IL (US)

(72) Inventors: CHONG HIN CHEE, Gelugor (MY); TOMASZ CHMIEL, Krakow (PL); SZYMON SIKORA, Krakow (PL); MICHAL HOJWA, Krakow (PL)

(21) Appl. No.: 17/937,195

(22) Filed: Sep. 30, 2022

(51) Int. Cl. H04N 21/454; G10L 15/02; G10L 25/57

(52) U.S. Cl. CPC H04N 21/4542; G10L 15/02; G10L 25/57

(57) ABSTRACT

Techniques for heightened video redaction based on audio are provided. A first level of redaction is applied to an individual captured in a video recording. Audio signatures in the video recording associated with the individual captured in the video recording are identified. It is determined that that the audio signatures, in a context of the video recording, will increase a likelihood of personally identifying the individual captured in the video recording. A second level of redaction is applied to the individual captured in the video recording when it is determined that the likelihood of personally identifying the individual captured in the video recording has increased.

### BACKGROUND

The use of video cameras is ever increasing. It is quite likely that a person in a public space is having their image, and possibly audio, recorded by at least one video camera at all times. Public cameras, such as those used to monitor traffic, provide surveillance of sensitive public areas, etc., are becoming ubiquitous. There are also a wide variety of semi-public cameras, such as those used to cover schools, commercial and public buildings, college campuses, corporate campuses, etc. There is even an increase in the number of cameras covering private residences (e.g. doorbell cameras, home security cameras, etc.).

The increase in the use of cameras is even more pronounced in the field of public safety, especially that of law enforcement. A police officer's vehicle may be equipped with multiple cameras (dashboard cameras, etc.) that capture images as well as audio from an area immediately surrounding the vehicle as well from inside the vehicle. Police officers being equipped with Body Worn Cameras (BWC) that record both video and audio is moving toward becoming universal. Police departments are also beginning to explore drones equipped with cameras as first responders.

When a public safety incident occurs, there are often requests for public safety agencies to release any available video that is related to the incident. In some cases, compliance with such requests may be mandated by Freedom of Information Act (FOIA) statutes. Although the video may be released, there are items that may be redacted. For example, in general, minors who appear in any video would be redacted. Likewise, any person not directly involved in the incident (e.g. bystanders, etc.) may be redacted to protect their privacy. Witnesses to the incident may be redacted to protect their safety, as disclosure of a witness's identity may put the witness in danger. Regardless of the reason why, in many cases, persons appearing in the video may be redacted to prevent identification.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments

FIG. 1 is an example of different levels of redaction that may be done on a video in accordance with the heightened video redaction based on audio data techniques described herein.

FIG. 2 is an example flow diagram for an implementation of the heightened video redaction based on audio data techniques described herein.

FIG. 3 is an example of a device that may implement the heightened video redaction based on audio data techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Although redacting a person's facial image in a video may make it difficult to personally identify that person, a problem arises when the video includes audio data. In particular, a problem arises when the video includes audio data that is audio of the person's speech and that speech includes characteristics, which can be referred to as audio signatures, that are not common within the area where the recording was made. For example, in a recording that is generated within the United States of America, a person whose audio signature includes use of Australian colloquial language (e.g. “No worries mate,” etc.) may be easier to personally identify as there may not be a significant number of people in the vicinity of the recording area who speak with such an audio signature.

In some cases, the audio signature may be sufficient to personally identify the individual. For example, if a recording occurs in a neighborhood with only one person who speaks with a particular audio signature, it is quite likely that is the person whose face has been redacted. Even if there is more than one person in the area that speaks with a particular audio signature, the audio signature may provide a clue as to the identity of the speaker. For example, assume there are two people who speak with similar audio signatures (e.g. Australian accent/vernacular) in a recording area, one of whom is thin and the other heavyset. The audio signature may allow the set of potential speakers to be reduced to those two individuals. If only the face of the person is blurred, it would generally not be difficult to identify the speaker based on their body appearance. This would be applicable to any other identifiable visual characteristics (e.g. tattoos, walking gait, etc.).

The techniques described herein overcome these problems individually and collectively. When redacting a video of a person speaking, the face of the individual may be redacted with a first level of redaction (e.g. face only). The person's speech may be monitored to detect audio signatures. The context of the area where the recording occurred (e.g. area proximate to the recording) can be analyzed to determine if the audio signature of the person speaking is unique enough within that context that it would be useful in identifying the speaker.

If the audio signature would be unique enough within the context of the recording area, a second level of redaction may be applied. For example, instead of redacting just the face, the entire body outline of the speaker may be redacted. In some cases, this may not be sufficient as the movements within body outline may still be used to identify the speaker. For example, if the speaker has a sufficiently unique walking gait, a body outline redaction may still allow identification. In such cases, a third level of redaction may be applied that further obfuscates the speaker's entire body.

In addition, in cases where the context of the recording and the nature of the audio signature would clearly identify the speaker, the audio itself may be muted in the redacted video and replaced with text captioning. In some cases, the text captioning may be modified to reflect the gist of the speech, rather than the exact speech. For example, “No worries mate” may be replaced with the text “No problem” to reflect common language usage in the area where the recording was made. To aid officials in releasing the redacted video, when the system does any type of heightened redaction, an explanation of the reasons for doing so may be provided.

A method for heightened video redaction based on audio is provided. The method includes applying a first level of redaction to an individual captured in a video recording. The method also includes identifying audio signatures in the video recording associated with the individual captured in the video recording. The method also includes determining that the audio signatures, in a context of the video recording, will increase a likelihood of personally identifying the individual captured in the video recording. The method also includes applying a second level of redaction to the individual captured in the video recording when it is determined that the likelihood of personally identifying the individual captured in the video recording has increased.

In one aspect, determining that the audio signatures will increase the likelihood of personally identifying the individual captured in the video recording further includes determining audio signatures of a majority of people within an area proximate to a camera that captured the video recording and determining that the audio signatures of the individual captured in the video recording is not included within the majority of people within the area. In one aspect the method includes applying a third level of video redaction to the individual captured in the video recording when the combination of the audio signatures and visual characteristics of the individual captured in the video recording uniquely identify the individual captured in the video recording.

In one aspect the method includes muting the audio of the individual captured in the video recording and providing a transcript of the muted audio. In one aspect providing the transcript of the muted audio further includes sanitizing the transcript to prevent identification of the individual captured in the video recording. In one aspect the method includes providing, on the redacted video, an indication of a reason for the redaction. In one aspect of the method the audio signatures are at least one of unique phrases, accents, and speech habits.

A system for heightened video redaction based on audio is provided. The system includes a processor and a memory coupled to the processor. The memory contains a set of instructions thereon that when executed by the processor cause the processor to apply a first level of redaction to an individual captured in a video recording. The instructions further cause the processor to identify audio signatures in the video recording associated with the individual captured in the video recording. The instructions further cause the processor to determine that the audio signatures, in a context of the video recording, will increase a likelihood of personally identifying the individual captured in the video recording. The instructions further cause the processor to apply a second level of redaction to the individual captured in the video recording when it is determined that the likelihood of personally identifying the individual captured in the video recording has increased.

In one aspect the instructions on the memory to determine that the audio signatures will increase the likelihood of personally identifying the individual captured in the video recording further comprises instructions to determine audio signatures of a majority of people within an area proximate to a camera that captured the video recording and determine that the audio signatures of the individual captured in the video recording is not included within the majority of people within the area. In one aspect the instructions on the memory further comprise instructions to apply a third level of video redaction to the individual captured in the video recording when the combination of the audio signatures and visual characteristics of the individual captured in the video recording uniquely identify the individual captured in the video recording.

In one aspect the instructions on the memory further comprise instructions to mute the audio of the individual captured in the video recording and provide a transcript of the muted audio. In one aspect the instructions on the memory to provide the transcript of the muted audio further comprises instructions to sanitize the transcript to prevent identification of the individual captured in the video recording. In one aspect the instructions on the memory further comprises instructions to provide, on the redacted video, an indication of a reason for the redaction. In one aspect of the system the audio signatures are at least one of unique phrases, accents, and speech habits.

A non-transitory processor readable medium containing a set of instructions thereon for heightened video redaction based on audio is provided. The instructions, that when executed by a processor cause the processor to apply a first level of redaction to an individual captured in a video recording. The instructions further cause the processor to identify audio signatures in the video recording associated with the individual captured in the video recording. The instructions further cause the processor to determine that the audio signatures, in a context of the video recording, will increase a likelihood of personally identifying the individual captured in the video recording. The instructions further cause the processor to apply a second level of redaction to the individual captured in the video recording when it is determined that the likelihood of personally identifying the individual captured in the video recording has increased.

In one aspect the instructions on the non-transitory processor readable medium to determine that the audio signatures will increase the likelihood of personally identifying the individual captured in the video recording further comprises instructions to determine audio signatures of a majority of people within an area proximate to a camera that captured the video recording and determine that the audio signatures of the individual captured in the video recording is not included within the majority of people within the area. In one aspect the instructions on the non-transitory processor readable medium further comprises instructions to apply a third level of video redaction to the individual captured in the video recording when the combination of the audio signatures and visual characteristics of the individual captured in the video recording uniquely identify the individual captured in the video recording.

In one aspect the instructions on the non-transitory processor readable medium further comprises instructions to mute the audio of the individual captured in the video recording and provide a transcript of the muted audio. In one aspect the instructions on the non-transitory processor readable medium to provide the transcript of the muted audio further comprises instructions to sanitize the transcript to prevent identification of the individual captured in the video recording. In one aspect the instructions on the non-transitory processor readable medium further comprises instructions to provide, on the redacted video, an indication of a reason for the redaction.

Further advantages and features consistent with this disclosure will be set forth in the following detailed description, with reference to the figures.

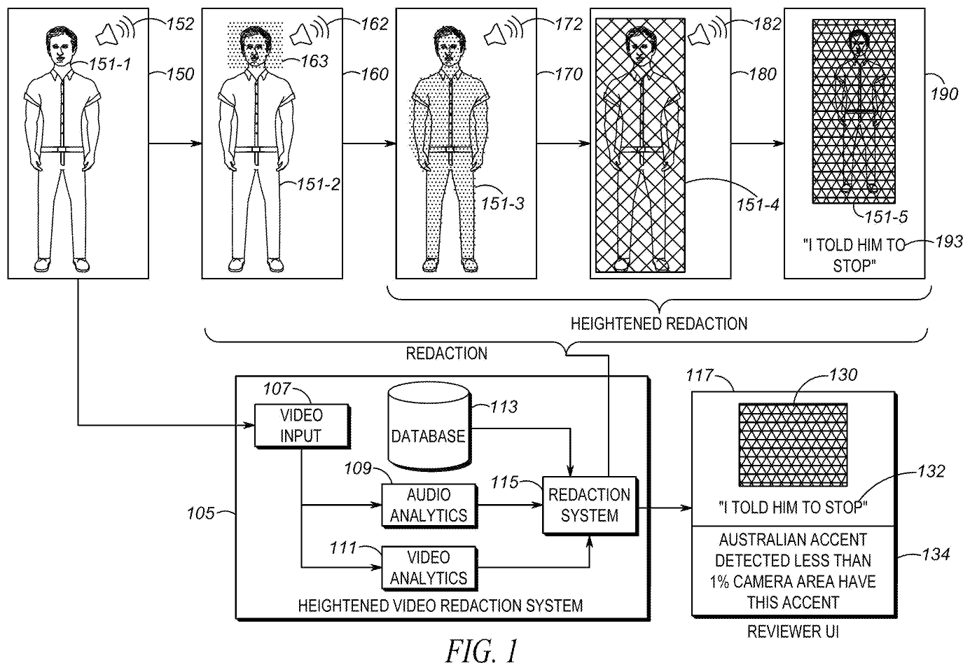

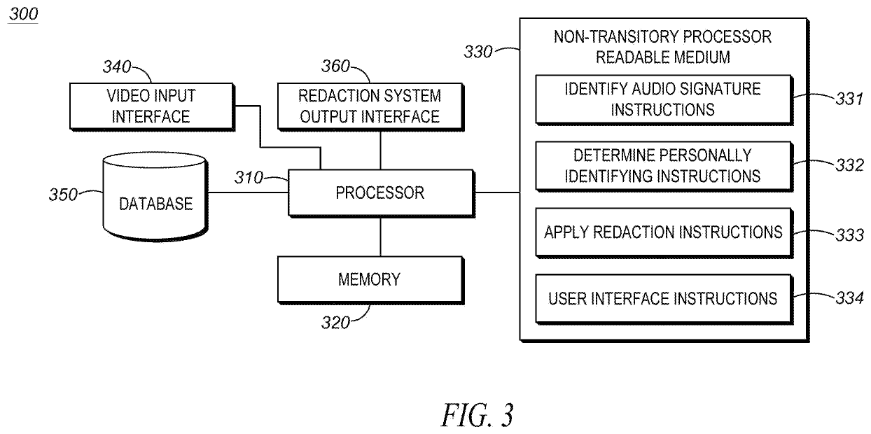

FIG. 1 is an example of different levels of redaction that may be done on a video in accordance with the heightened video redaction based on audio data techniques described herein. FIG. 1 includes a heightened video redaction system 105 which may be used to receive an input video and redact the video according to the techniques described herein. FIG. 3 depicts a hardware device that may implement the functionality described with respect to the heightened video redaction system 105.

The heightened video redaction system 105 may include a video input interface 107. The video input interface 107 may receive video, which may also include audio, that is to be redacted. As explained above, there are many reasons why a video may need to be redacted and the techniques described herein are usable regardless of the reason the video is being redacted. The video may have been generated from any number of video recording sources, including police dashboard cameras, body worn cameras, private surveillance cameras, cell phone cameras, etc. The techniques described herein are usable with all forms of video recordings, regardless of their source.

The heightened video redaction system 105 may also include an audio analytics system 109. The audio analytics system 109 may process video received from the video input interface 107 to identify different speakers within the video. There are many known techniques for speaker diarization (i.e. identification of individual speakers within an audio stream) currently available. The techniques described herein are suitable for use with any currently available or later developed speaker diarization technique.

In addition to speaker diarization, the audio analytics system 109 may analyze the speech of each speaker to identify audio signatures. Audio signatures will be described in further detail below, but may include things such as accents, speech habits, unique terminology, etc. In general, an audio signature is a characteristic of a person's speech that may be used to distinguish that person's manner of speaking. Depending on how unique that manner of speaking is, the audio characteristic may be used, alone or in conjunction with visual information from a video, to personally identify a speaker. For purposes of the remainder of this discussion, personally identifying an individual means to identify a specific person (e.g. by name, etc.) or a subset of people small enough that anonymity of the person is no longer maintained.

The audio analytics system 109 may be a trained machine learning model that is trained on a dataset that includes many different audio signatures. Some example audio signatures may include unique, often repeated phrases (e.g. “like”, “ya'know”, etc.), excessive vulgarities, phrases associated with a specific population (e.g. Cockney phrases, etc.), slang terminology, etc. Another type of audio signature may be accents associated with certain locations (e.g. Australia, France, England, Malaysian, etc.).

Audio signatures might also include characteristics that are not related to actual words. For example, speech habits, such as excessive use of filler sounds, such as “um” and “err” may be an audio signature useful to identify a person. In addition, an audio signature may include terminology used by a subset of a population. For example words which may be code words for other things (e.g. referring to the police as “Five-O”). Another such example may be religious terminology that may be used to identify a person's religion.

Yet another example of audio signatures may be speech impediments (e.g. stammering, stuttering, Tourette's Syndrome, etc.). It should be understood that these are simply examples of the types of items that could be used as audio signatures. A machine learning model may be trained using speech including these, and any other, type of audio signature. Machine learning models trained to identify audio signatures are known. The techniques described herein may utilize any currently available or later developed technique for identifying audio signatures.

The heightened video redaction system 105 may also include video analytics system 111. The video analytics system 111 may analyze video received from the video input interface 107 to identify unique visual characteristics of speakers in the received video. For example, things like identifiable tattoos, manner of dress, body type (e.g. thin, heavyset, etc.), missing appendages, scars, etc. may be identified by the video analytics system 111.

The video analytics system 111 may also identify the received video to identify unique types of movement by speakers within the received video. Some examples of unique types of movement may include things such as limping or a walking gait that is unusual.

The video analytics system 111 may be a trained machine learning model that is trained on a dataset that includes many different types of visual characteristics, such as those described above. Machine learning models trained to identify visual characteristics are known. The techniques described herein may utilize any currently available or later developed technique for identifying visual characteristics.

The heightened video redaction system 105 may also include database 113. The database 113 is not intended to imply a single data source that stores relevant data, but rather is intended to represent storage of data anywhere, regardless of system, that may provide useful context information for the area near where a video recording was captured. Typical systems may include data sources such as data sources that include demographic information about the population in an area (e.g. census data sources, etc.). Data sources may also include public safety data sources, such as computer aided dispatch (CAD)/evidence systems, which may store information about the speakers in a video (e.g. nationality, ethnicity, gang affiliation, etc.). As will be explained in further detail below, the information stored in the database 113 may be used to determine the level of redaction that is performed on a video.

The heightened video redaction system 105 may also include redaction system 115. The redaction system 115 may utilize the output from the audio analytics system 109, the video analytics system 111, and the database 113 to determine the level and type of redaction necessary to perform on a video based on the associated audio. As will be explained in further detail below, the redaction system 115 may determine the level of redaction necessary to reduce the likelihood that a speaker in a video could be personally identified based on the redacted video.

Operation of the heightened video redaction system 105 will now be described by way of a simplified redaction of a video 150. For purposes of ease of description only, assume that there is only a single speaker 151-1 in the video. It should be understood that the techniques described with respect to a single speaker could be repeated for each speaker present in the video 150. In addition, assume that the video 150 includes audio 152 in which the speaker says, “I told him to stop.”

In operation, the original video 150 may be sent to the heightened video redaction system 105. The redaction system 115 may identify the speaker 151-1. Using known video redaction techniques the redaction system 115 may generate a redacted video 160 that redacts the speaker 151-2 by blurring the region 163 around the speaker's face. It should be understood that the remaining portions of speaker 151-2 remain un-redacted and any identifiable visual features on the body of the person 151-2 would remain visible.

The redaction system 115 may then use the audio analytics system 109 to determine if there are any audio signatures that can be determined from analyzing the original video 160. Assume in this example that the audio analytics system 109 has determined that speaker 151-1 speaks with an Australian accent. The redaction system 115 may then retrieve information from the database 113 to determine the context of the area proximate to the camera that recorded the original video 150.

For example, if the database 113 indicates that the area where the recording occurred has a high percentage of people who speak with an Australian accent, then this particular audio signature is relatively useless as far as personally identifying the speaker 151-2, and the redacted video 160 could continue to include the audio 162 (which is the same as the audio 152 from the original video 150). Thus, redacted video 160 sufficiently assures the speaker 151-2 remains unidentifiable.

Continuing with the example, if the database 113 indicates that the area where the recording occurred has a low percentage of people who speak with an Australian accent, the redaction system 115 may utilize the video analytics system 111 to determine if the speaker 151-1 has any visual characteristics that would aid in identifying the speaker, given that the subset of people with the area of the camera that speak with an Australian accent is relatively low. For example, assume the speaker 151-1 has a tattoo visible on their upper right arm, which would still be visible if only the face was redacted. As should be clear, personally identifying the speaker 151-1 becomes easier as the set of possible people is first reduced to people in the area who speak with an Australian accent and is then further reduced by those who also have tattoos on their upper right arm.

In response, the redaction system 115 may apply a second level of redaction to create a redacted video 170. Redacted video 170 may still include audio 172 (which is the same as the audio 152 from the original video 150). However, the redaction of the speaker 151-3 may go beyond simply blurring the speakers face. In this example, the blurring could include blurring of the arms, legs, and torso of the speaker 151-3. Note, the general movements of speaker 151-3 may still be discerned (e.g. raises hand, sits down, etc.) but the visual details of the speaker (e.g. tattoos, etc.) will be blurred. Therefore, the original audio 172 could still be included in the redacted video 170, but the level of redaction is increased.

Continuing further with the example, the video analytics system 111 may determine that the speaker 151-1 has unique movement characteristics that may be identifiable even if the speaker's arms and legs are blurred. Some examples could include that the person is in a wheelchair, walks using a cane, has a limp, walks with an identifiable gait, etc. In such cases, simply blurring the speaker's 151-1 limbs would be insufficient to reduce the ability to personally identify the speaker 151-1. In some cases, it actually makes it easier to personally identify the speaker 151-1 (e.g. look for people with Australian accents who use a wheelchair).

If the video analytics system 111 determines that the speaker 151-1 has visual characteristics, such as movement characteristics that cannot be redacted using simple blurring techniques, a third level of redaction may be applied as shown in redacted video 180. In redacted video 180, the speaker 151-4 may be completely redacted, thus obfuscating their image entirely. For example, the immediate area around the person may be replaced with a black box. Using heavy motion averaging redaction techniques, it can be ensured that the entire area around the speaker 151-4 is heavily redacted such that no information about the movement characteristics of the speaker is disclosed. The original audio 182 (which is the same as the audio 152 from the original video 150) may still be included in redacted video 180.

Continuing further with the example, in some cases, the redaction system 115 may determine that including the original audio 152 and/or any visual representation of the speaker 151-2, 151-3 at all would be sufficient to personally identify the speaker 151-1. For example, if there is only one person in the area of the video recording who speaks with an Australian accent, it is more likely than not that that is the speaker 151-1. In such cases, a redacted video 190 may be created that, in addition to fully redacting the video of the speaker 151-5 as was done in the redacted video 180, removes the actual audio 152 and replaces it with a transcript 193 of the audio, thus removing the ability to identify the speaker based on accent. For example, in this case, the audio transcript may be “I told him to stop” 193.

Although redacted video 190 is described with respect to fully redacting the speaker 151-5, it should be understood that the audio replacement technique could be used regardless of the level of visual redaction applied. For example, blurring the face of the speaker 151-1 as was done in redacted video 160 may be sufficient if removing the audio signature based on accent results in a set of possible speakers that cannot be personally identifiable. In other words, if the transcript says, “I told him to stop” it is not possible to identify the speaker, because without the audio signature (e.g. Australian accent), there is nothing in the transcript 193 that would lead to identification of the speaker 151-1.

In some cases, a simple transcription alone may not be sufficient to reduce the possibility that the speaker 151-1 can be personally identified. For example, consider the case where the audio signature consists of a phrase normally associated with a particular group (e.g. Australian vernacular “No worries mate.”). Simply replacing the audio with the transcript is not helpful because the phrase still identifies a subset of people who may use that particular language phrase. In some cases, the transcript 193 may be modified to include the meaning of what the speaker was saying rather than the exact words. For example, the transcript might say, “No problem” which may be a much more common phrase used in the location where the video was recorded. As such, the meaning of what the speaker 151-1 said is conveyed, without having to use the speakers actual words. Such a modification of the transcript could be referred to as producing a sanitized transcript.

As the heightened video redaction system 105 is operating, it may be monitored by a human (not shown) using a reviewer user interface system 117. The reviewer user interface system 117 may display to the reviewer the type of redaction that is being proposed (blurring face, body, entire area, etc.) 130 as well as any changes to the audio (e.g. replacing with transcript, replacing with sanitized transcript, etc.) 132. The reviewer user interface system 117 may also include the reason 134 that the level of redaction was chosen (e.g. Australian accent detected. Less than 1% in camera area have an Australian accent, etc.). The human reviewer may be given the option to accept or reject the redactions proposed by the heightened video redaction system 105.

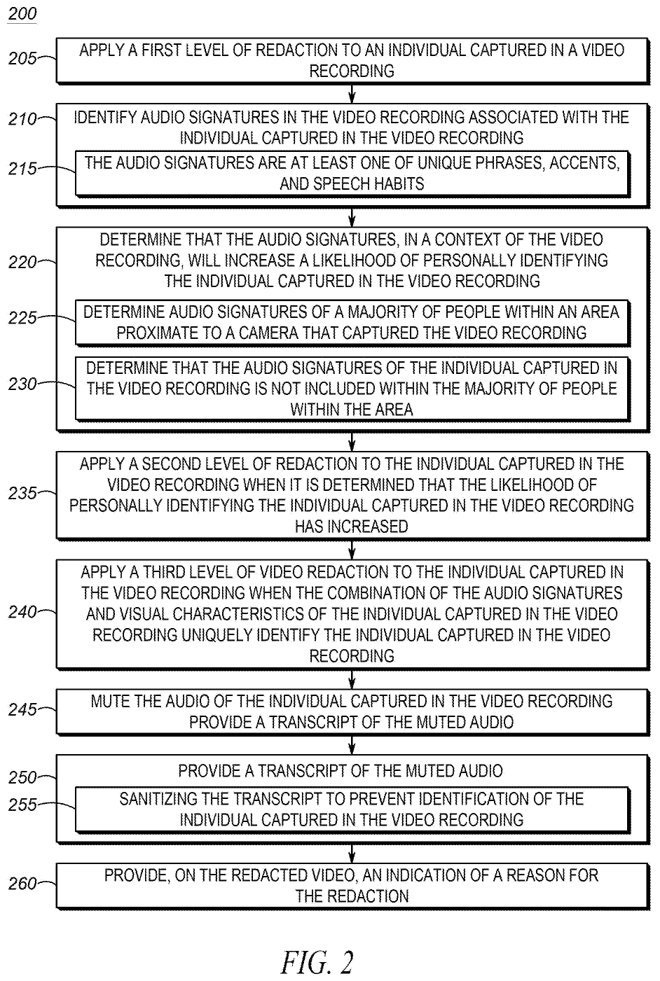

FIG. 2 is an example flow diagram 200 for an implementation of the heightened video redaction based on audio data techniques described herein. In block 205, a first level of redaction may be applied to an individual captured in a video recording. The source of the video recording is unimportant. What should be understood is that the video recording may include the likeness of the individual as well as any speech provided by the individual. It should further be understood that the video recording may include multiple individuals, and the process described herein may occur for each individual. The process is being described in terms of a single individual for ease of description, and not by way of limitation. As described above, the first level of redaction may be a simple facial blurring of the individual in the video.

In block 210, audio signatures in the video recording associated with the individual captured in the video recording may be identified. As explained above, audio signatures are characteristics of the individual's speech that may be useful in personally identifying the individual. The particular type of audio signature is unimportant and any audio signature that would aid in identifying the individual would be suitable. Block 215 describes several such audio signatures as being at least one of unique phrases, accents, and speech habits. Although block 215 describes several examples of audio signatures, it should be understood that the techniques described herein are suitable for use with any type of audio signature that is useful in personally identifying an individual.

In block 220, it may be determined that the audio signatures, in a context of the video recording, will increase a likelihood of personally identifying the individual captured in the video recording. Certain types of audio signatures in certain areas may be more likely to be useful in personally identifying an individual than others. For example, an Australian accent audio signature would likely not be useful in identifying a person in a video recording made in Australia. In contrast, for a video recording made in the United States, it is likely that the presence of an Australian accent would increase the likelihood of personally identifying the individual, due to the fact that significantly fewer people in the United States have Australian accents.

In block 225, the audio signatures of a majority of the people within an area proximate to a camera that captured the video recording may be determined. The area proximate to the camera can be variable based on the type of audio signature. For example, in the case of an accent associated with persons from a particular country, the area may be very wide, to include the entire country. In the case of an audio signature that includes a regional dialect, the area may be the region where that dialect is common. In some cases, the area may be as small as a neighborhood. What should be understood is that the area proximate to the camera is based on the particular type of audio signature.

In block 230, it may be determined that the audio signatures of the individual captured in the video recordings is not included within the majority of people within the area. In other words, there is something different about the audio signature of the individual captured in the video recording that would cause the audio signature to stand out from the majority of the population within the area of the video recording. Because the individual stands out from the majority, it may be easier to personally identify the individual.

In block 235, a second level of redaction may be applied to the individual captured in the video recording when it is determined that the likelihood of personally identifying the individual captured in the video recording has increased. If the audio signature of the individual is likely to cause the individual to have a greater likelihood of being identified, simple facial redaction may not be enough to keep the individual anonymous. In such cases, a second level of redaction, or heightened redaction, may be applied. For example, instead of just blurring the individual's face, the face, arms, legs, and torso may be blurred.

In block 240, a third level of video redaction may be applied to the individual captured in the video recording when the combination of the audio signatures and visual characteristics of the individual captured in the video recording uniquely identify the individual captured in the video recording. As explained above, in some cases movement characteristics of the individual (e.g. limping, unique walking gait, etc.) can be useful, in combination with the audio signatures, to identify the individual. In such cases, a third level of redaction, or heightened redaction, may be applied. For example, the third level of heightened redaction may be to completely black out the individual within the redacted video, such that the person appears as a black rectangle. What should be understood is that the third level of redaction is of greater degree than the second level, with even less visual information provided.

In block 245, the audio of the individual captured in the video recording may be muted. In some cases, the audio signature of the individual captured in the video recording may be so unique within the proximity of the capturing video camera, that the audio signature itself is sufficient to identify the person. For example, if the individual speaks with a certain accent within the proximity of where the recording is created there is only one person who speaks with that accent, it becomes quite easy to determine who the individual captured in the video recording is. In such a situation, no level of visual redaction would be useful, as it is the audio signature alone that is useful in the identification of the individual. In such cases, the audio itself may be redacted by muting, thus creating a further level of heightened redaction.

In block 250, a transcript of the muted audio may be provided. Although muting the audio may be useful in protecting the identity of the individual, it also means that the information being conveyed in the audio is no longer present. A transcript, which may be created via a speech-to-text system, allows the information conveyed in the audio to be maintained while not revealing the audio signature of the individual.

In block 255, providing the transcript further comprises sanitizing the transcript to prevent identification of the individual captured in the video recording. In some cases, the transcript itself may be insufficient to protect the identity of the individual. For example, if a certain phrases are used that would be useful in identifying the individual, whether those phrases are in audio or transcript format makes no difference. It is the presence of the phrase itself that is problematic. In such cases, the transcript may be changed, which can be referred to as being sanitized, to prevent the identification of the individual. For example, the words used in the transcript could be changed to use words that would more likely be used in the area of the video recording without changing the meaning of what the individual said.

In block 260, an indication of a reason for the redaction may be provided on the redacted video. As explained above, there may be a human redaction reviewer that is monitoring the output of the redaction video. By providing the reasoning behind the redactions, the human can determine if the redaction is proper. If so, the redacted video may be released to whomever is requesting it. If the redaction is not proper (either the redaction level is heightened too much or is not heightened enough) the human reviewer can review the reasoning behind the level of redaction performed and cause the level of redaction to be heightened or lowered.

FIG. 3 is an example of a device 300 that may implement the heightened video redaction based on audio data techniques described herein. It should be understood that FIG. 3 represents one example implementation of a computing device that utilizes the techniques described herein. Although only a single processor is shown, it would be readily understood that a person of skill in the art would recognize that distributed implementations are also possible. For example, the various pieces of functionality described above (e.g. video analytics, audio analytics, redaction system, etc.) could be implemented on multiple devices that are communicatively coupled. FIG. 3 is not intended to imply that all the functionality described above must be implemented on a single device.

Device 300 may include processor 310, memory 320, non-transitory processor readable medium 330, video input interface 340, database 350, and redaction system output interface 360.

Processor 310 may be coupled to memory 320. Memory 320 may store a set of instructions that when executed by processor 310 cause processor 310 to implement the techniques described herein. Processor 310 may cause memory 320 to load a set of processor executable instructions from non-transitory processor readable medium 330. Non-transitory processor readable medium 330 may contain a set of instructions thereon that when executed by processor 310 cause the processor to implement the various techniques described herein.

For example, medium 330 may include identify audio signature instructions 331. The identify audio signature instructions 331 may cause the processor to receive input video that is the subject of heightened redaction from the video input interface 340. The identify audio signature instructions 331 may implement the audio analytics functions described above to identify audio signatures of one or more speakers within the received input video. The identify audio signature instructions 331 are described throughout this description generally, including places such as the description of blocks 210 and 215.

The medium 330 may include determine personally identifying instructions 332. The determine personally identifying instructions 332 may cause the processor to compare the audio signatures previously determined to audio signatures found in the area proximate to the camera that made the recording. The processor may access database 350 to retrieve information, such as census and demographic type information, about the area in proximity of the camera. The processor may compare the determined audio signature to the data retrieved from the database to determine if the audio signature may cause the speaker to be personally identifiable.

In addition, the determine personally identifying instructions 332 may cause the processor to implement the video analytics functions described above to analyze the input video to determine if there are any visual characteristics of the speaker that would aid in personally identifying an individual. The determine personally identifying instructions 332 are described throughout this description generally, including places such as the description of blocks 220-230.

The medium 330 may include apply redaction instructions 333. The apply redaction instructions 333 may cause the processor to apply a first level of redaction to the video received from the video input interface. Depending on the results of the determine personally identifying instructions 332, the apply redaction instructions 333 may cause the processor to apply second and third levels of redaction as well. In addition, the apply redaction instructions 333 may cause the processor to replace the audio with a transcript. The redacted video may be output via the redaction system output interface 360. The apply redaction instructions 333 are described throughout this description generally, including places such as the description of blocks 205 and 235-255.

The medium 330 may include user interface instructions 334. The user interface instructions 334 may cause the processor to output a user interface through the redaction system output interface 360. Among other functions described above, the user interface instructions may cause the processor to display, on the redacted video, the reason why the redactions were made. The user interface may also allow the user to accept or deny the redactions. The user interface instructions 334 are described throughout this description generally, including places such as the description of block 260.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot implement machine learning algorithms to identify audio signatures based on dataset training and automatically redact video, among other features and functions set forth herein).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for heightened video redaction based on audio comprising:
applying a first level of visual redaction to an individual captured in a video recording;
identifying audio signatures in the video recording associated with the individual captured in the video recording;
determining that the audio signatures, in a context of the video recording, will increase a likelihood of personally identifying the individual captured in the video recording; and
applying a second level of visual redaction to the individual captured in the video recording when it is determined that the likelihood of personally identifying the individual captured in the video recording has increased.

2. The method of claim 1 wherein determining that the audio signatures will increase the likelihood of personally identifying the individual captured in the video recording further comprises:
determining audio signatures of a majority of people within an area proximate to a camera that captured the video recording; and
determining that the audio signatures of the individual captured in the video recording is not included within the majority of people within the area.

3. The method of claim 1 further comprising:
applying a third level of video redaction to the individual captured in the video recording when the combination of the audio signatures and visual characteristics of the individual captured in the video recording uniquely identify the individual captured in the video recording.

4. The method of claim 1 further comprising:
muting the audio of the individual captured in the video recording; and
providing a transcript of the muted audio.

5. The method of claim 4 wherein providing the transcript of the muted audio further comprises:
sanitizing the transcript to prevent identification of the individual captured in the video recording.

6. The method of claim 1 further comprising:
providing, on the redacted video, an indication of a reason for the redaction.

7. The method of claim 1 wherein the audio signatures are at least one of unique phrases, accents, and speech habits.

8. A system for heightened video redaction based on audio comprising:
a processor; and
a memory coupled to the processor containing a set of instructions thereon that when executed by the processor cause the processor to:
apply a first level of visual redaction to an individual captured in a video recording;
identify audio signatures in the video recording associated with the individual captured in the video recording;
determine that the audio signatures, in a context of the video recording, will increase a likelihood of personally identifying the individual captured in the video recording; and
apply a second level of visual redaction to the individual captured in the video recording when it is determined that the likelihood of personally identifying the individual captured in the video recording has increased.

9. The system of claim 8 wherein the instructions to determine that the audio signatures will increase the likelihood of personally identifying the individual captured in the video recording further comprises instructions to:
determine audio signatures of a majority of people within an area proximate to a camera that captured the video recording; and
determine that the audio signatures of the individual captured in the video recording is not included within the majority of people within the area.

10. The system of claim 8 further comprising instructions to:
apply a third level of video redaction to the individual captured in the video recording when the combination of the audio signatures and visual characteristics of the individual captured in the video recording uniquely identify the individual captured in the video recording.

11. The system of claim 8 further comprising instructions to:
mute the audio of the individual captured in the video recording; and
provide a transcript of the muted audio.

12. The system of claim 11 wherein the instructions to provide the transcript of the muted audio further comprises instructions to:
sanitize the transcript to prevent identification of the individual captured in the video recording.

13. The system of claim 8 further comprising instructions to:
provide, on the redacted video, an indication of a reason for the redaction.

14. The system of claim 8 wherein the audio signatures are at least one of unique phrases, accents, and speech habits.

15. A non-transitory processor readable medium containing a set of instructions thereon for heightened video redaction based on audio that when executed by a processor cause the processor to:
apply a first level of visual redaction to an individual captured in a video recording;
identify audio signatures in the video recording associated with the individual captured in the video recording;
determine that the audio signatures, in a context of the video recording, will increase a likelihood of personally identifying the individual captured in the video recording; and
apply a second level of visual redaction to the individual captured in the video recording when it is determined that the likelihood of personally identifying the individual captured in the video recording has increased.

16. The non-transitory processor readable medium of claim 15 wherein the instructions to determine that the audio signatures will increase the likelihood of personally identifying the individual captured in the video recording further comprises instructions to:
determine audio signatures of a majority of people within an area proximate to a camera that captured the video recording; and
determine that the audio signatures of the individual captured in the video recording is not included within the majority of people within the area.

17. The non-transitory processor readable medium of claim 15 further comprising instructions to:
apply a third level of video redaction to the individual captured in the video recording when the combination of the audio signatures and visual characteristics of the individual captured in the video recording uniquely identify the individual captured in the video recording.

18. The non-transitory processor readable medium of claim 15 further comprising instructions to:
mute the audio of the individual captured in the video recording; and
provide a transcript of the muted audio.

19. The non-transitory processor readable medium of claim 18 wherein the instructions to provide the transcript of the muted audio further comprises instructions to:
sanitize the transcript to prevent identification of the individual captured in the video recording.

20. The non-transitory processor readable medium of claim 15 further comprising instructions to:
provide, on the redacted video, an indication of a reason for the redaction.
